(19) United States
(12) Patent Application Publication
(10) Pub. No.: US 2007/0274494 A1
(43) Pub. Date: Nov. 29, 2007

(54) Computer-readable recording medium having recorded therein telephone-call connection program, telephone-call connection method, and telephone-call connection apparatus

(75) Inventors: Yasuhiko Awamoto, Yokohama (JP); Soichi Nishiyama, Kawasaki (JP); Rieko Ohba, Kawasaki (JP); Chizu Tuge, Kawasaki (JP); Yoshihiko Ueno, Kawasaki (JP)

Correspondence Address: STAAS & HALSEY LLP, SUITE 700, 1201 NEW YORK AVENUE, N.W., WASHINGTON, DC, 20005, US

(73) Assignees: FUJITSU LIMITED, Kawasaki-shi (JP); FUJITSU BROAD SOLUTION & CONSULTING, INC., Tokyo (JP)

(21) Appl. No.: 11/643,791

(22) Filed: Dec. 22, 2006

(30) Foreign Application Priority Data
May 15, 2006 (JP) 2006-135593

(51) Int. Cl. H04M 3/42

(52) U.S. Cl. 379/210.01

(57) ABSTRACT

A computer-readable recording medium having recorded therein a telephone-call connection program for controlling telephone calling with the schedule of the other party of a call and a call importance level therefor being taken into account. A connection-request receiving block extracts a transmission-source telephone number and a transmission-destination telephone number and identifies the other party of the call from the transmission-destination telephone number. Then, a call-importance-level determination block determines the call importance level of the call for the other party of the call. A schedule determination block determines whether the current time falls in a response-rejection time zone of the other party of the call. A connection determination block determines according to the response-rejection time zone and the call importance level whether telephone calling is necessary. When telephone calling is necessary, a telephone calling block makes telephone calling directed to a terminal corresponding to the transmission-destination telephone number.

### CROSS-REFERENCE TO RELATED APPLICATIONS

This application is based upon and claims the benefits of priority from the prior Japanese Patent Application No. 2006-135593, filed on May 15, 2006, the entire contents of which are incorporated herein by reference.

### BACKGROUND OF THE INVENTION

1. Field of the Invention

The present invention relates to computer-readable recording media having recorded therein a telephone-call connection program, telephone-call connection methods, and telephone-call connection apparatuses, and particularly to a computer-readable recording medium having recorded therein a telephone-call connection program, a telephone-call connection method, and a telephone-call connection apparatus that control telephone calling according to the schedule of the other party of a call.

2. Description of the Related Art

Computers have been used for controlling telephone-call connections and more-advanced control functions have been implemented. For example, when a telephone registered member specifies his or her schedule in advance, if he or she cannot receive a call, a computer automatically responds to the caller and does not perform telephone calling directed to the telephone registered member. In addition, instead of the automatic response to the caller, a function for transferring the call to a telephone which is not usually used, specified by the telephone registered member in advance has also been implemented. Such functions may be provided as a telephone-call connection service of a telecommunications carrier or as functions of a private branch exchange (PBX) installed in an organization.

There is a demand for receiving only important telephone calls in a predetermined period of time while rejecting as many other calls as possible. For example, a system engineer who uses a portable telephone on business wants to reject as many telephone calls as possible when not in working hours but wants to receive emergency calls such as a call related to a system failure even when not in the working hours.

There has been known a system in which telephone calling is performed when a telephone caller determines that the call is important even during a time zone when the receiver determines not to receive calls (such as a system disclosed in Japanese Unexamined Patent Application Publication No. 2005-341476). In the system, when a telephone call is made during a time zone when the receiver determines not to receive calls, a message indicating that a telephone call cannot be received is sent to the telephone caller. When the telephone caller sends a signal indicating that the call is about an important issue, telephone calling is performed. By using the system, a telephone registered member can receive a call related to an issue having a high importance level even during a time zone when the member has determined not to receive calls.

In the technology disclosed in Japanese Unexamined Patent Application Publication No. 2005-341476, the telephone caller determines the importance level of a call, which is not a level determined by the receiver. In other words, even if the telephone caller determines an importance issue, that issue is not necessarily important for the receiver. Conversely, an unimportant issue which the telephone caller determines may be an emergency issue for the receiver. Generally, it is possible to estimate the call importance level for a receiver from who the telephone caller is.

### SUMMARY OF THE INVENTION

In view of the foregoing, it is an object of the present invention to provide a computer-readable recording medium having recorded therein a telephone-call connection program, a telephone-call connection method, and a telephone-call connection apparatus that allow whether a telephone-call connection is possible to be determined with the schedule of the other party of the call and a call importance level for the other party of the call being taken into account.

To accomplish the above object, according to the present invention, there is provided a computer-readable recording medium having recorded therein a telephone-call connection program for controlling telephone calling according to the schedule of the other party of a call. The telephone-call connection program, recorded in the computer-readable recording medium, makes a computer serve as a registered-member-information storage unit for storing identification information for identifying telephone registered members individually and telephone numbers assigned to the telephone registered members, in association with each other; a transmission-source-information storage unit for storing, for each telephone registered member, a telephone number assigned to a telephone caller and information indicating the call importance level of a call from the telephone caller for the telephone registered member, in association with each other; a schedule-information storage unit for storing, for each telephone registered member, information on a response-rejection time zone that indicates a time zone when the telephone registered member does not want to receive telephone calling; when receiving a telephone-call connection request that includes a transmission-source telephone number and a transmission-destination telephone number, a connection-request receiving unit for extracting the transmission-source telephone number and the transmission-destination telephone number from the received telephone-call connection request and also for referring to the registered-member-information storage unit to identify a telephone registered member corresponding to the extracted transmission-destination telephone number; a call-importance-level determination unit for referring to the transmission-source-information storage unit to determine a call importance level corresponding to the transmission-source telephone number extracted by the connection-request receiving unit, for the telephone registered member identified by the connection-request receiving unit; a schedule determination unit for referring to the schedule-information storage unit to determine whether the current time falls in the response-rejection time zone of the telephone registered member identified by the connection-request receiving unit; a connection determination unit for determining that telephone calling is necessary when the schedule determination unit determines that the current time does not fall in the response-rejection time zone; and for determining whether the call importance level determined by the call-importance-level determination unit is equal to or higher than a reference importance level specified in advance, when the schedule determination unit determines that the current time falls in the response-rejection time zone, and for determining that telephone calling is necessary when the call importance level determined by the call-importance-level determination unit is equal to or higher than the reference importance level; and a telephone calling unit for performing telephone calling directed to a terminal corresponding to the transmission-destination telephone number extracted by the connection-request receiving unit when the connection determination unit determines that telephone calling is necessary.

To accomplish the above object, according to the present invention, there is also provided a telephone-call connection method for controlling telephone calling according to the schedule of the other party of a call. This telephone-call connection method includes the steps of: when receiving a telephone-call connection request that includes a transmission-source telephone number and a transmission-destination telephone number, a connection-request receiving unit extracting the transmission-source telephone number and the transmission-destination telephone number from the received telephone-call connection request and also referring to a registered-member-information storage unit that stores identification information for identifying telephone registered members individually and telephone numbers assigned to the telephone registered members, in association with each other, to identify a telephone registered member corresponding to the extracted transmission-destination telephone number; a call-importance-level determination unit referring to a transmission-source-information storage unit that stores, for each telephone registered member, a telephone number assigned to a telephone caller and information indicating the level of importance of a call from the telephone caller for the telephone registered member, in association with each other, to determine a call importance level corresponding to the transmission-source telephone number extracted by the connection-request receiving unit, for the telephone registered member identified by the connection-request receiving unit; a schedule determination unit referring to a schedule-information storage unit that stores, for each telephone registered member, information on a response-rejection time zone that indicates a time zone when the telephone registered member does not want to receive telephone calling, to determine whether the current time falls in the response-rejection time zone of the telephone registered member identified by the connection-request receiving unit; a connection determination unit determining that telephone calling is necessary when the schedule determination unit determines that the current time does not fall in the response-rejection time zone; and determining whether the call importance level determined by the call-importance-level determination unit is equal to or higher than a reference importance level specified in advance, when the schedule determination unit determines that the current time falls in the response-rejection time zone, and determining that telephone calling is necessary when the call importance level determined by the call-importance-level determination unit is equal to or higher than the reference importance level; and a telephone calling unit performing telephone calling directed to a terminal corresponding to the transmission-destination telephone number extracted by the connection-request receiving unit when the connection determination unit determines that telephone calling is necessary.

To accomplish the above object, according to the present invention, there is further provided a telephone-call connection apparatus for controlling telephone calling according to the schedule of the other party of a call. This telephone-call connection apparatus includes a registered-member-information storage unit for storing identification information for identifying telephone registered members individually and telephone numbers assigned to the telephone registered members, in association with each other; a transmission-source-information storage unit for storing, for each telephone registered member, a telephone number assigned to a telephone caller and information indicating the call importance level of a call from the telephone caller for the telephone registered member, in association with each other; a schedule-information storage unit for storing, for each telephone registered member, information on a response-rejection time zone that indicates a time zone when the telephone registered member does not want to receive telephone calling; when receiving a telephone-call connection request that includes a transmission-source telephone number and a transmission-destination telephone number, a connection-request receiving unit for extracting the transmission-source telephone number and the transmission-destination telephone number from the received telephone-call connection request and also for referring to the registered-member-information storage unit to identify a telephone registered member corresponding to the extracted transmission-destination telephone number; a call-importance-level determination unit for referring to the transmission-source-information storage unit to determine a call importance level corresponding to the transmission-source telephone number extracted by the connection-request receiving unit, for the telephone registered member identified by the connection-request receiving unit; a schedule determination unit for referring to the schedule-information storage unit to determine whether the current time falls in the response-rejection time zone of the telephone registered member identified by the connection-request receiving unit; a connection determination unit for determining that telephone calling is necessary when the schedule determination unit determines that the current time does not fall in the response-rejection time zone; and for determining whether the call importance level determined by the call-importance-level determination unit is equal to or higher than a reference importance level specified in advance, when the schedule determination unit determines that the current time falls in the response-rejection time zone, and for determining that telephone calling is necessary when the call importance level determined by the call-importance-level determination unit is equal to or higher than the reference importance level; and a telephone calling unit for performing telephone calling directed to a terminal corresponding to the transmission-destination telephone number extracted by the connection-request receiving unit when the connection determination unit determines that telephone calling is necessary.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 shows an outline of the present invention.

FIG. 2 shows the configuration of a system according to an embodiment of the present invention.

FIG. 3 shows a flow of processes performed when an employee makes a telephone call from the outside of the company.

FIG. 4 shows the hardware structure of a telephonic-communication control server.

FIG. 5 is a functional block diagram of the telephonic-communication control server.

FIG. 6 shows an example data structure of an employee information table.

FIG. 7 shows an example data structure of a meeting-room information table.

FIG. 8 shows an example data structure of a telephone directory table.

FIG. 9 shows an example data structure of a schedule information table.

FIG. 10 shows an example data structure of a call-device information table.

FIG. 11 shows an example data structure of a reception history table.

FIG. 12 is a flowchart showing the procedure of connection control processing.

FIG. 13 is a flowchart showing the procedure of a telephone calling process.

### DESCRIPTION OF THE PREFERRED EMBODIMENTS

An embodiment of the present invention will be described below in detail by referring to the drawings. An outline of the present invention will be explained first, and then, an embodiment will be described concretely.

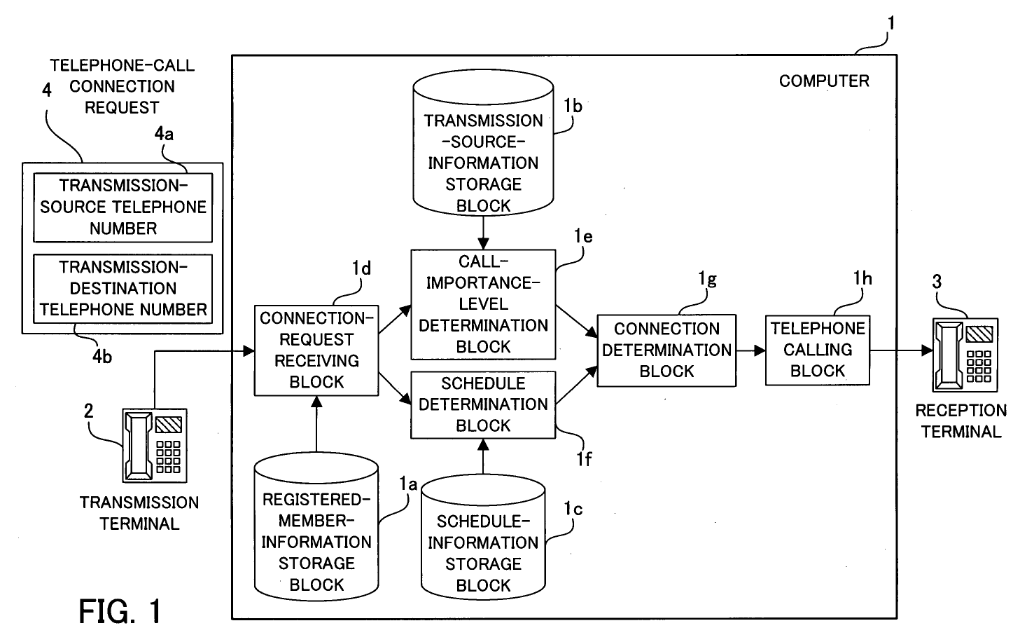

FIG. 1 shows a basic idea of the present invention, applied to an embodiment. A computer 1 receives a telephone-call connection request from a transmission terminal 2 and performs telephone calling directed to a reception terminal 3 when the computer 1 determines that the telephone-call connection is necessary. The computer 1 includes a registered-member-information storage block 1a, a transmission-source-information storage block 1b, a schedule-information storage block 1c, a connection-request receiving block 1d, a call-importance-level determination block 1e, a schedule determination block 1f, a connection determination block 1g, and a telephone calling block 1h.

The registered-member-information storage block 1a stores identification information for identifying telephone registered members individually and telephone numbers assigned the telephone registered members, in association with each other. The identification information of each registered member is, for example, the name thereof or a unique number assigned thereto.

The transmission-source-information storage block 1b stores, for each registered member, the telephone number of a telephone caller and information indicating the call importance level of a telephone call from that telephone caller for the registered member, in association with each other. The call importance level is expressed, for example, by one of five ranks. The call importance level is determined based on the past experiences of each registered member and is updated, if necessary.

The schedule-information storage block 1c stores, for each registered member, information on a response-rejection time zone during which the registered member does not want to receive telephone calls. The response-rejection time zone includes, for example, when the registered member is using a telephone on business, when the registered member is out of usual work due to a business trip or a meeting, and when the registered member has finished work and stays home.

When the connection-request receiving block 1d receives a telephone-call connection request 4 from the transmission terminal 2, the connection-request receiving block 1d extracts a transmission-source telephone number 4a and a transmission-destination telephone number 4b from the telephone-call connection request 4. The transmission-source telephone number 4a is a telephone number assigned to the telephone caller, and the transmission-destination telephone number 4b is the telephone number indicating the other party of the call, specified by the telephone caller. The connection-request receiving block 1d refers to the registered-member-information storage block 1a to identify the registered member corresponding to the extracted transmission-destination telephone number 4b.

The call-importance-level determination block 1e refers to the transmission-source-information storage block 1b to determine the call importance level corresponding to the transmission-source telephone number 4a extracted by the connection-request receiving block 1d, for the registered member identified by the connection-request receiving block 1d. The schedule determination block if refers to the schedule-information storage block Ic to determine whether the current time falls in the response-rejection time zone of the registered member identified by the connection-request receiving block 1d.

When the schedule determination block if determines that the current time does not fall in the response-rejection time zone, the connection determination block 1g determines that telephone calling is necessary. When the schedule determination block 1f determines that the current time falls in the response-rejection time zone, the connection determination block 1g determines whether the call importance level determined by the call-importance-level determination block 1e is equal to or higher than a reference importance level specified in advance. Only when the call importance level is equal to or higher than the reference importance level, the connection determination block 1g determines that telephone calling is necessary. The reference importance level is set in advance to a specific value, such as three in the five ranks.

When the connection determination block 1g determines that telephone calling is necessary, the telephone calling block 1h makes telephone calling directed to a reception terminal 3 corresponding to the transmission-destination telephone number 4b extracted by the connection-request receiving block id. When the other party of the call responds to the telephone calling directed to the reception terminal 3, telephonic communication is enabled between the transmission terminal 2 and the reception terminal 3.

With the computer 1, when the transmission terminal 2 sends a telephone-call connection request 4, the connection-request receiving block 1d extracts the transmission-source telephone number 4a and the transmission-destination telephone number 4b, and also identifies the other party of the call from the transmission-destination telephone number 4b. Then, the call-importance-level determination block 1e determines the call importance level of the call for the other party of the call. The schedule determination block if also determines whether the current time falls in a response-rejection time zone of the other party of the call. The connection determination block 1g determines according to the response-rejection time zone and the call importance level whether telephone calling is necessary or not. When telephone calling is necessary, the telephone calling block 1h makes telephone calling directed to the reception terminal 3 corresponding to the transmission-destination telephone number 4b.

With this system, even in a time zone when a registered member has specified as a response-rejection time zone, he or she can receive a call that is regarded as highly important. Since each registered member can specify the call importance level for each telephone caller according to his or her experience, the call importance level can be more appropriately determined.

An embodiment of the present invention will be described below concretely by referring to the drawings.

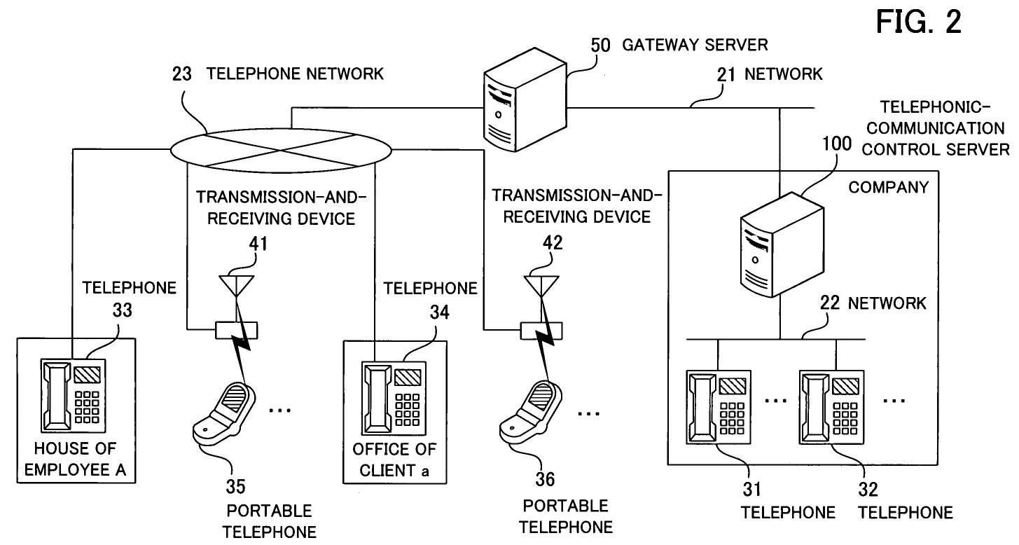

FIG. 2 shows the structure of a telephonic-communication control system according to an embodiment. The telephonic-communication control system determines whether to connect a call directed to an employee from a client or another employee of the company and performs telephone calling to an appropriate telephone when having determined to connect the call. The telephonic-communication control system includes a telephonic-communication control server 100, a gateway server 50, networks 21 and 22, a telephone network 23, telephones 31, 32, 33, 34, . . . , portable telephones 35, 36, . . . , and transmission-and-receiving devices 41, 42, . . . .

The telephonic-communication control server 100 is installed in the company and is connected to telephones 31, 32, . . . in the company through the network 22 in the company. For example, the telephone 31 is placed on a desk of an employee, and the telephone 32 is placed in a meeting room. The telephonic-communication control server 100 is also connected to the network 21.

The telephones 33, 34, . . . are connected to the telephone network 23, which is under the management of a telecommunications carrier. For example, the telephone 33 is placed in a house of an employee, and the telephone 34 is placed in an off ice of a client of the company. The transmission-and-receiving devices 41, 42, . . . are connected to the telephone network 23. When the portable telephones 35, 36, . . . enter the radio area of any of the transmission-and-receiving devices 41, 42, . . . , telephonic communication is allowed through the corresponding transmission-and-receiving device. For example, the portable telephone 35 has been given to an employee from the company, and the portable telephone 36 is held by a client.

In the networks 21 and 22, audio data is exchanged by the use of Internet Protocol (IP). Audio communications performed through such a network is generally called IP telephony. The network 21 and the telephone network 23 are connected through the gateway server 50. The gateway server 50 is a computer under the management of the telecommunications carrier, and has a function of mutually converting audio data transmitted and received by the network 21 and an audio signal flowing through the telephone network 23. With this, telephonic communication is allowed between a telephone at the side of the network 21 and a telephone at the side of the telephone network 23.

It is assumed here that the company has assigned an IP telephone number (hereinafter called a business telephone number) to each employee. When a client makes a phone call to an employee of the company from the outside of the company, he or she specifies the corresponding business telephone number. The telephonic-communication control server 100 receives all telephone-call connection requests transmitted with business telephone numbers specified. For example, when a client transmits a telephone-call connection request by using the telephone 34 or the portable telephone 36, the telephone-call connection request is sent to the telephonic-communication control server 100 through the telephone network 23 and the network 21.

The telephonic-communication server 100 holds schedule information of each employee. The telephonic-communication control server 100 also holds a telephone directory listing, for each employee, the telephone numbers of clients and other employees and information that indicates the levels of importance of calls therefrom. When a client sends a telephone-call connection request, the telephonic-communication control server 100 determines whether to perform telephone calling according to the schedule of the employee who is to be the other party of the call and the level of importance of the call from the caller for that employee.

When the telephonic-communication control server 100 determines to perform telephone calling, the telephonic-communication control server 100 performs telephone calling directed to an appropriate telephone according to the current schedule of the employee. For example, when the employee is working at his or her desk, telephone calling is made to a telephone placed on the desk; when the employee is out of office, telephone calling is made to his or her portable telephone. In this manner, the telephonic-communication control server 100 plays a roll in relaying telephonic communication between a client and an employee. When the telephonic-communication control server 100 determines not to perform telephone calling, the telephonic-communication control server 100 returns a response message telling that the employee cannot receive the call, to the transmission source of the telephone-call connection request.

When an employee makes a phone call to another employee from the outside of the company, the telephonic-communication control server 100 determines whether to perform telephone calling and relays the call, in the same manner as when a client makes a phone call to an employee except that the telephonic-communication control server 100 transmits a telephone-call connection request to a portable telephone or another call device held by the employee instead of the employee transmitting a telephone-call connection request to the telephonic-communication control server 100 from the portable telephone or another call device held by the employee.

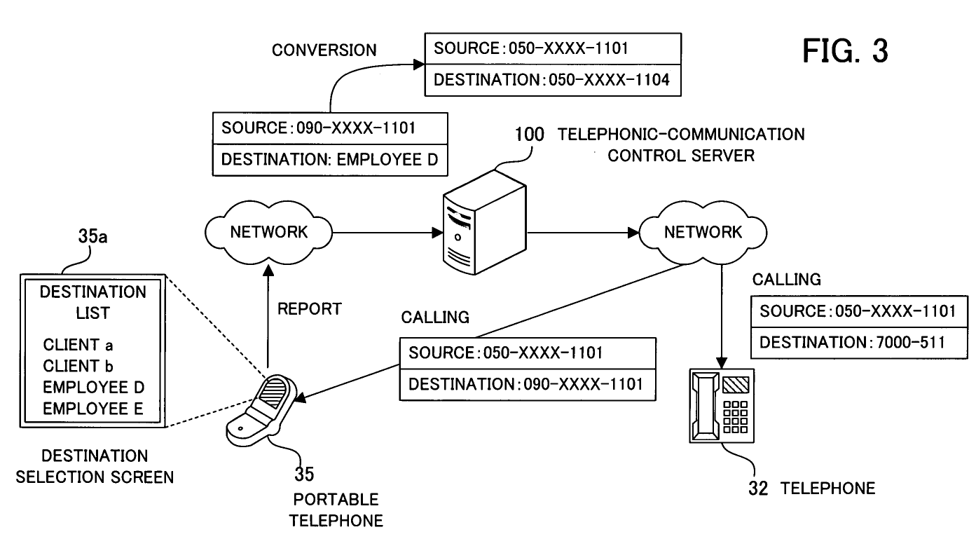

FIG. 3 is a view showing a flow of processing performed when an employee makes a phone call to another employee from the outside of the company. When an employee A makes a phone call to an employee D by using the portable telephone 35, the employee A first obtains a list of persons who has been registered in the telephone directory of the employee A, from the telephonic-communication control server 100. Then, the employee A refers to a destination selection screen 35a displayed on the portable telephone 35 to specify the employee D as the other party of a call, and reports that to the telephonic-communication control server 100.

The telephonic-communication control server 100 refers to the telephone directory of the employee A to set the business telephone number of the employee D as a destination telephone number. The telephonic-communication control server 100 also sets the business telephone number of the employee A as a transmission-source telephone number. With this, the telephonic-communication control server 100 considers that the telephone having the business telephone number of the employee A has transmitted a telephone-call connection request with the business telephone number of the employee D being specified.

The telephonic-communication control server 100 determines whether to perform telephone calling directed to the employee D. When the telephonic-communication control server 100 determines to perform telephone calling directed to the employee D, the telephonic-communication control server 100 performs telephone calling simultaneously directed to an appropriate telephone (for example, the telephone 32 placed at a meeting room) of the employee D, who is the other party of the call, and to the portable telephone 35 of the employee A, who is the request source. When both employees A and D responds to the telephone calling, the telephonic-communication control server 100 starts relaying audio data between the two telephone connections to allow telephonic communication between the employees A and D.

With this system configuration, the employees do not need to carry information on the telephone numbers of their clients and other employees when going out of the company. Therefore, individual-information leakage can be prevented, such as leakage which may occur when an employee loses his or her portable telephone having a telephone directory, outside the company.

The above-described processing in which a portable telephone obtains a list of persons registered in the telephone directory of the caller from the telephonic-communication control server 100 and the caller selects the other party of a call from the obtained list and reports that to the telephonic-communication control server 100 can be implemented by a web technology. More specifically, the data communications between the portable telephone and the telephonic-communication control server 100 can be implement by HyperText Transfer Protocol (HTTP). In the present embodiment, a description of details of the processing from when a portable telephone obtains a list for the caller from the telephonic-communication control server 100 to when the telephonic-communication control server 100 identifies the business telephone numbers of the caller and the other party of a call is omitted.

The hardware structure of the telephonic-communication control server 100 will be described next.

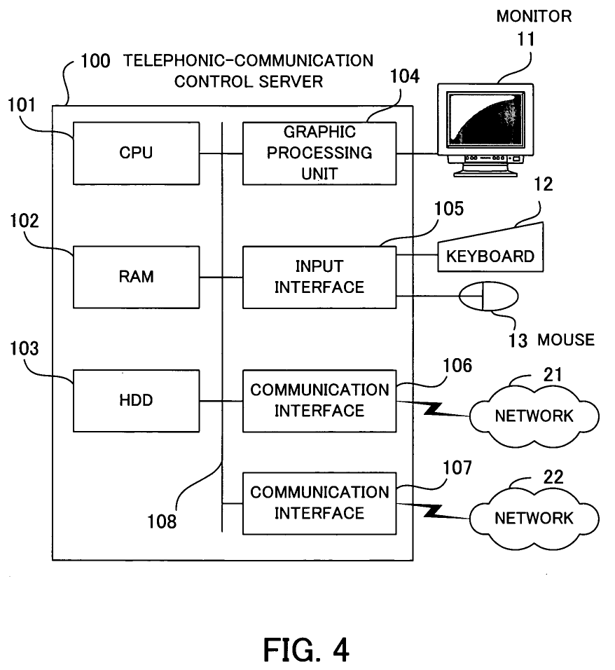

FIG. 4 shows the hardware structure of the telephonic-communication control server 100. The whole of the telephonic-communication control server 100 is controlled by a central processing unit (CPU) 101. The CPU 101 is connected to a random access memory (RAM) 102, a hard disk drive (HDD) 103, a graphic processing unit 104, an input interface 105, and communication interfaces 106 and 107, through a bus 108.

The RAM 102 temporarily stores at least a part of an operating system (OS) program and an application program to be executed by the CPU 101. The RAM 102 also stores various types of data necessary for processing executed by the CPU 101. The HDD 103 stores the operating system program and the application program.

The graphic processing unit 104 is connected to a monitor 11. The graphic processing unit 104 displays an image on the screen of the monitor 11 according to an instruction sent from the CPU 101. The input interface 105 is connected to a keyboard 12 and a mouse 13. The input interface 105 receives signals from the keyboard 12 and the mouse 13 and sends them to the CPU 101 through the bus 108. The communication interface 106 is connected to the network 21. The communication interface 107 is connected to the network 22.

With the above-described hardware structure, processing functions of the present embodiment are implemented.

The program-module configuration of the telephonic-communication control server 100 will be described next.

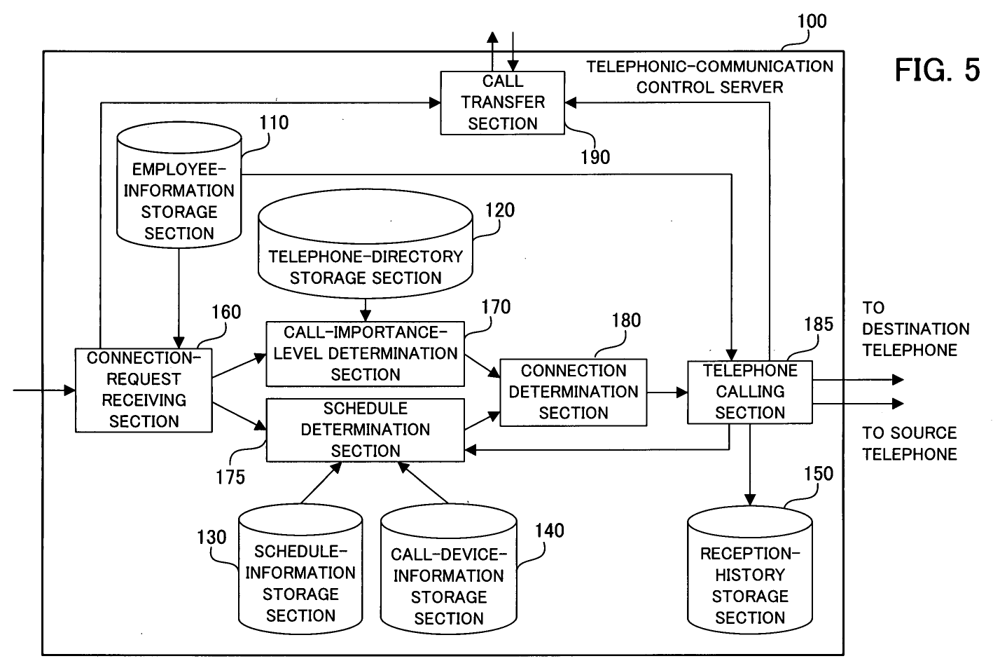

FIG. 5 is a block diagram of functions of the telephonic-communication control server 100. The telephonic-communication control server 100 includes an employee-information storage section 110, a telephone-directory storage section 120, a schedule-information storage section 130, a call-device-information storage section 140, a reception-history storage section 150, a connection-request receiving section 160, a call-importance-level determination section 170, a schedule determination section 175, a connection determination section 180, a telephone calling section 185, and a call transfer section 190. The connection-request receiving section 160, the telephone calling section 185, and the call transfer section 190 can perform audio communication with telephones and portable telephones through the network 21. The telephone calling section 185 and the call transfer section 190 can perform audio communication with telephones inside the company through the network 22.

The employee-information storage section 110 stores the business telephone number of each employee and a plurality of telephone numbers used for telephone calling to the employee, including the telephone number of the portable telephone given thereto by the company and the home telephone number. The employee-information storage section 110 also stores the extension numbers of telephones placed at meeting rooms inside the company.

The telephone-directory storage section 120 stores information on the telephone directory of each employee. The telephone directory includes, for each caller such as a client, the telephone number of the caller and information indicating the level of importance of a call from the caller. The level of importance of a call is specified by each employee according to his or her experience.

The schedule-information storage section 130 stores schedule information of each employee. The schedule information includes the working state of each employee, such as working at a desk or out of office, in association with the date and time zone.

The call-device-information storage section 140 stores information on call devices which can be used for telephone calling to each employee. One or more call devices which can be used are specified for each working state of each employee with priority levels attached. For example, for a “meeting” state, the extension telephone at the meeting room is specified as a call device having a first priority and the portable telephone is specified as a call device having a second priority. The call-device-information storage section 140 also stores information on an incoming-call importance level for each working state of each employee. The incoming-call importance level means the lowest of the levels of importance of calls for which telephone calling is allowed. Telephone calling is only allowed when a caller having the level of importance of a call equal to or higher than the incoming-call importance level makes a phone call.

The reception-history storage section 150 stores history information of telephone-call connection requests received by the telephonic-communication control server 100. The history information includes the name of the transmission source of each telephone-call connection request and whether telephone calling was allowed. The history information is used by an administrator of the telephonic-communication control server 100 to check the operation state of telephonic-communication control.

When the connection-request receiving section 160 receives a telephone-call connection request from a telephone or a portable telephone, the connection-request receiving section 160 extracts the telephone number of the transmission source and the business telephone number, which is the telephone number of the transmission destination, from the received telephone-call connection request. Then, the connection-request receiving section 160 refers to the employee-information storage section 110 to identify the employee to which the extracted business telephone number has been assigned.

When the telephonic-communication control server 100 receives a telephone-call making request from an employee through the Web, the business telephone number of the employee who is the request source and the business telephone number of the employee who is the specified other party of the call are identified, and a telephone-call connection request that includes the identified business telephone numbers of the transmission source and destination is sent to the connection-request receiving section 160. With this, the connection-request receiving section 160 does not need to determine whether the person who has requested to make the phone call is a client or an employee.

The call-importance-level determination section 170 searches the telephone directory stored in the telephone-directory storage section 120 of the destination employee identified by the connection-request receiving section 160 to determine the call importance level of the caller indicated by the transmission-source telephone number extracted by the connection-request receiving section 160.

The schedule determination section 175 searches the schedule information stored in the schedule-information storage section 130 of the destination employee identified by the connection-request receiving section 160 to determine the current working state of the employee. The schedule determination section 175 refers to the call-device-information storage section 140 to determine the incoming-call importance level corresponding to the determined working state, and also identifies the cal device specified for the working state.

When the call importance level determined by the call-importance-level determination section 170 is equal to or higher than the incoming-call importance level determined by the schedule determination section 175, the connection determination section 180 determines that telephone calling is necessary. Otherwise, the connection determination section 180 determines that telephone calling is not necessary.

When the connection determination section 180 determines that telephone calling is necessary, the telephone calling section 185 performs telephone calling directed to the call device of the other party of the call, identified by the schedule determination section 175. More specifically, the telephone calling section 185 refers to the employee-information storage section 110 to identify the telephone number corresponding to the call device of the other party of the call, and performs telephone calling directed to the telephone indicated by the identified telephone number. When a plurality of call devices is specified, the telephone calling section 185 selects a call device having a higher priority and performs telephone calling. If no response is received within a predetermined period of time, the telephone calling section 185 selects a call device having the next higher priority and performs telephone calling. This procedure is repeated.

When the person who has made the telephone-call connection request is an employee, the telephone calling section 185 performs telephone calling directed to the telephone of the person in the same way as when performing telephone calling directed to the telephone of the other party of the call.

When the connection determination section 180 determines that telephone calling is not necessary, the telephone calling section 185 returns a response indicating that no response is made to telephone calling, to the transmission source of the telephone-call connection request. Then, the connection determination section 180 stores history information indicating the result of processing in the reception-history storage section 150.

The call transfer section 190 holds a telephone connection between the transmission source of the telephone-call connection request and the telephonic-communication control server 100 and a telephone connection between the telephonic-communication control server 100 and the call destination, in association with each other, and relays audio data between these two telephone connections. With this, telephonic communication is enabled between the transmission source of the telephone-call connection request and the call destination through the telephonic-communication control server 100.

The employee-information storage section 110 has an employee information table 110a indicating a list of employee information and a meeting-room information table 110b indicating a list of meeting-room information.

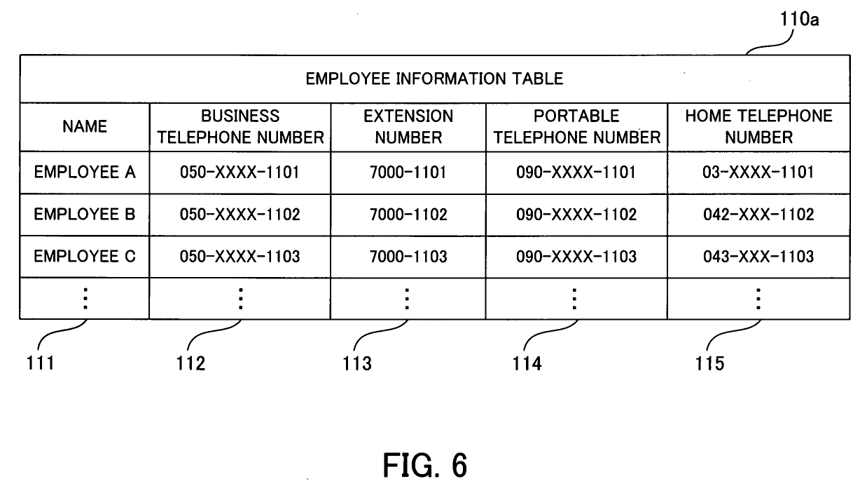

FIG. 6 shows an example data structure of the employee information table 110a. The employee information table 110a includes employee information associated with each employee and has a name field 111, a business-telephone-number field 112, an extension-number field 113, a portable-telephone-number field 114, and a home-telephone-number field 115. Information items corresponding to the fields, arranged in a row, are associated with each other and form employee information.

The name field 111 includes the name of an employee. The business-telephone-number field 112 includes a business telephone number assigned to the employee. An administrator associates the business telephone number with the employee in advance in one-to-one correspondence. The extension-number field 113 includes the extension number of a telephone placed on the desk of an employee in the company. The portable-telephone-number field 114 includes the telephone number of a portable telephone given to the employee. The home-telephone-number field 115 includes the home telephone number of the employee.

The employee information is registered by the administrator in advance. For example, for an employee A, information is registered which includes a business telephone number of 050-xxxx-1101, an extension number of 7000-1101, a portable telephone number of 090-xxxx-1101, and a home telephone number of 03-xxxx-1101. When the home telephone number of an employee is changed, the administrator updates the registered contents, if necessary, according to an application from the employee.

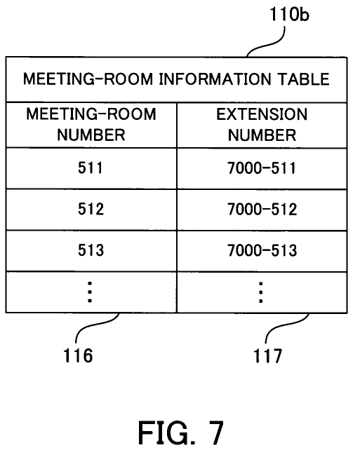

FIG. 7 shows an example data structure of the meeting-room information table 110b. The meeting-room information table 110b includes meeting-room information associated with each meeting room and has a meeting-room-number field 116 and an extension-number field 117. Information items corresponding to the fields, arranged in a row, are associated with each other and form meeting-room information.

The meeting-room-number field 116 includes the number of a meeting room in the company. The extension-number field 117 includes the extension number of a telephone placed in the meeting room. The administrator registers the meeting room information in advance. For example, information is registered which includes a meeting room number of 511 and an extension number of 7000-511 of the meeting room.

The telephone-directory storage section 120 has a telephone directory table indicating a list of telephone caller information for each employee.

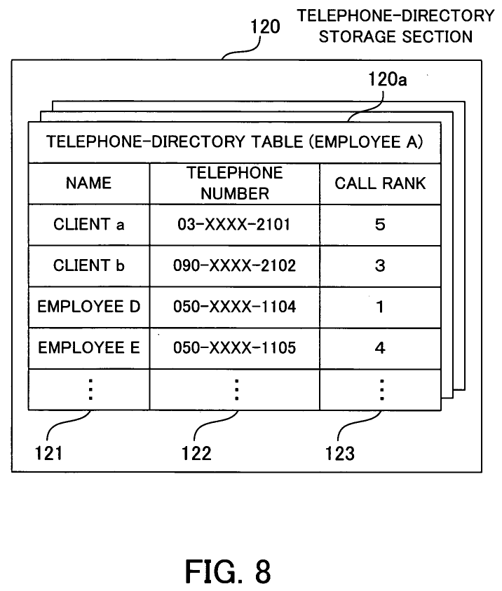

FIG. 8 shows an example data structure of the telephone directory table. The figure shows a telephone directory table 120a for the employee A. The telephone directory table 120a includes telephone caller information associated with each caller and has a name field 121, a telephone-number field 122, and a call-rank field 123. Information items corresponding to the fields, arranged in a row, are associated with each other and form telephone caller information.

The name field 121 includes the name of a telephone caller. The telephone caller is a client or an employee who may make a phone call to the employee for whom the telephone directory table 120a is made, namely, the employee A in the current case. The telephone-number field 122 includes the telephone number which the client or the employee uses to make a telephone call. The telephone number is that of a telephone placed at the office of the client or that of a portable telephone used by the client, or the business telephone number assigned to the employee. The call-rank field 123 includes a value indicating the call importance level of a call made by the telephone caller, for the employee for whom the telephone directory table 120a is made, namely the employee A in the current case. Specifically, one of “1” to “5” is set in the field 123. The highest level of importance of a call is indicated by “1”, and the lowest level of importance of a call is indicated by “5”.

The telephone caller information is registered by each employee, if necessary. For example, when a sales person starts transaction with a new client, the sales person registers information that includes a client name of client “a”, a telephone number of 03-xxxx-2101, and a call rank of “5”. The call rank is determined by the employee according to his or her experience. When the telephone number of a client is changed, or when the call rank of a particular telephone caller for an employee is changed, the employee updates the registered contents, if necessary.

The schedule-information storage section 130 includes, for each employee, a schedule information table indicating a list of schedule information.

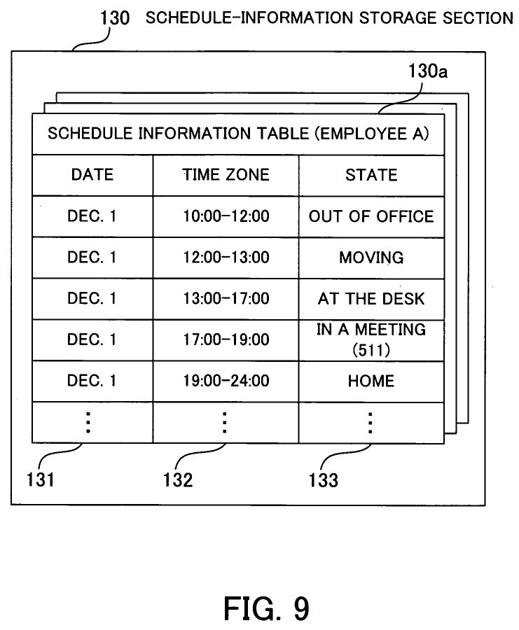

FIG. 9 shows an example data structure of the schedule information table. The figure shows a schedule information table 130a for the employee A. The schedule information table 130a includes schedule information associated with dates and time zones and has a date field 131, a time-zone field 132, and a state field 133. Information items corresponding to the fields, arranged in a row, are associated with each other and form schedule information.

The date field 131 includes the date of an schedule item. The time-zone field 132 includes the starting time and ending time of the schedule item. The state field 133 includes an expected working state at a time specified by the date specified in the date field 131 and the time zone specified in the time-zone field 132. Specifically, the state field 133 includes one of “out of office”, “moving”, “at the desk”, “in a meeting”, and “home”, where “out of office” means that the employee is working outside the company; “moving” means that the employee is moving to a place where he or she will perform work outside the company; “at the desk” means that the employee is working at his or her desk in the company; “in a meeting” means that the employee is in a meeting; and “home” means that the employee has finished working and stays home. The number of the meeting room where the meeting is being held is also described when “in a meeting” is specified.

The schedule information is registered by the administrator in advance. For example, information is registered in which the employee A will be “out of office” from 10 a.m. to 12 a.m. on December 1. The schedule information is collectively registered by the administrator every month according to an application from an employee, for example. When the schedule information is changed, the administrator updates the registered contents according to an application from the employee, if necessary.

The call-device-information storage section 140 has a call-device-information table indicating a list of call device information for each employee.

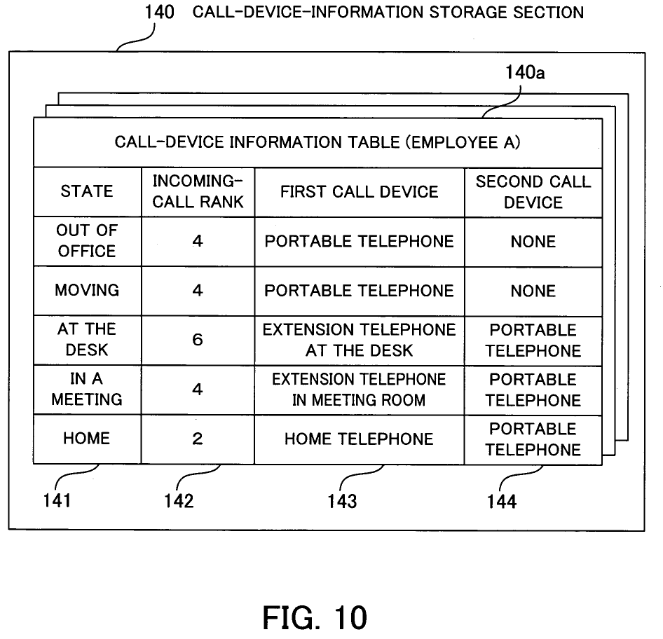

FIG. 10 shows an example data structure of the call-device-information table. The figure shows a call-device-information table 140a for the employee A. The call-device-information table 140a includes call-device information associated with each working state and has a state field 141, an incoming-call-rank field 142, a first-device field 143, and a second-device field 144. Information items corresponding to the fields, arranged in a row, are associated with each other and form call-device information.

The state field 141 includes a working state, one of “out of office”, “moving”, “at the desk”, “in a meeting”, and “home”, which mean the same as those included in the state field 133 of the schedule information table 130a. The incoming-call-rank field 142 includes a value indicating the incoming-call importance level at the working state specified in the state field 141. Specifically, one of “1” to “5” is set in the field 142. The highest level of importance of an incoming call is indicated by “1”, and the lowest level of importance of an incoming call is indicated by “5”.

The first-device field 143 includes the name of a call device selected first. Specifically, one of “extension telephone at the desk”, “extension telephone in a meeting room”, “portable telephone”, and “home telephone” is set in the field 143. The second-device field 144 includes the name of a call device selected next when no response is received from the call device specified in the field 143. Specifically, one of “extension telephone at the desk”, “extension telephone in a meeting room”, “portable telephone”, and “home telephone” is set in the field 144. If there is no alternative call device, “none” is set in the field 144.

The call-device information is registered by the administrator in advance according to an application from an employee. For example, information is registered indicating an incoming-call rank of “4”, a first call device of “portable telephone”, and a second call device of “none” for a working state of “out of office”. When the priority levels of call devices need to be changed, the administrator updates the registered contents according to an application from the employee, if necessary.

To further add an alternative call device, a field indicating a third call device needs to be added to the call-device-information table.

The reception history storage section 150 includes a reception history table 150a indicating a list of reception history.

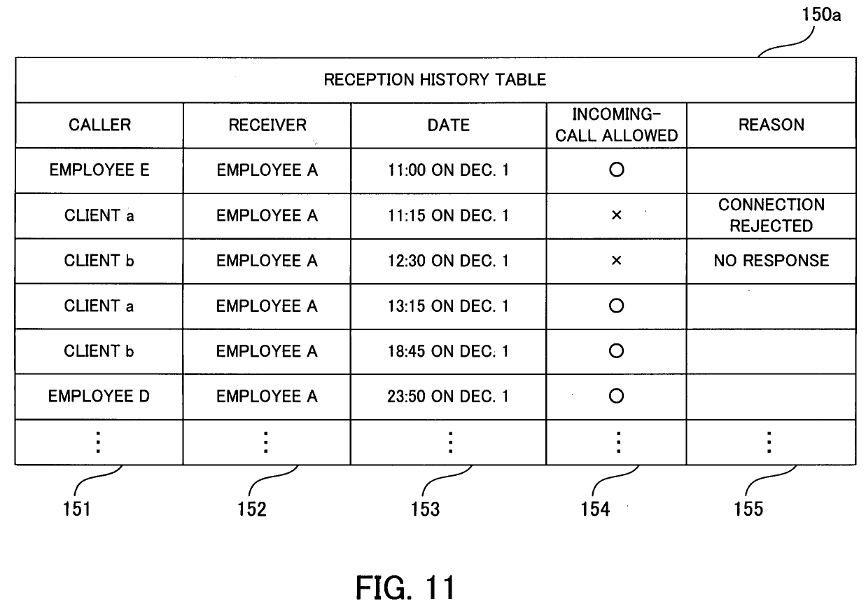

FIG. 11 shows an example data structure of the reception history table 150a. The reception history table 150a includes reception history associated with each telephone-call connection request and has a caller field 151, a receiver field 152, a date field 153, an incoming-call allowed field 154, and a reason field 155. Information items corresponding to the fields, arranged in a row, are associated with each other and form reception history information.

The caller field 151 includes the name of a telephone caller. The names of telephone callers correspond to those specified in the field 121 of the telephone directory table 120a. The receiver field 152 includes the name of the employee specified as the other party of the call. The names of employees correspond to those specified in the field 111 of the employee information table 110a. The date field 153 includes the date and time when the telephonic-communication control server 100 received the telephone-call connection request. The incoming-call allowed field 154 includes a success flag (indicated by a circle in the figure) when the telephone-call connection was completed, and includes a failure flag (indicated by x in the figure) when the telephone-call connection was not made. When the telephone-call connection was not made means when the connection determination section 180 determined that telephone calling was not necessary, or when there was no response to telephone calling. The reason field 155 includes a reason when the telephone-call connection was not made. Specifically, “connection rejected” or “no response” is set in the field 155. When the telephone-call connection was completed, nothing is specified in the field 155.

The history information is registered by the telephone calling section 185 every time the processing for a telephone-call connection request is completed. For example, information is registered indicating a telephone caller of “client a”, a receiver of “employee A”, a date of “11:15 on Dec. 1”, an incoming-call allowed of “failure (indicated by x)”, and a reason of “connection rejected”.

Details of processing executed in the system having the above-described structure and data structure will be described next.

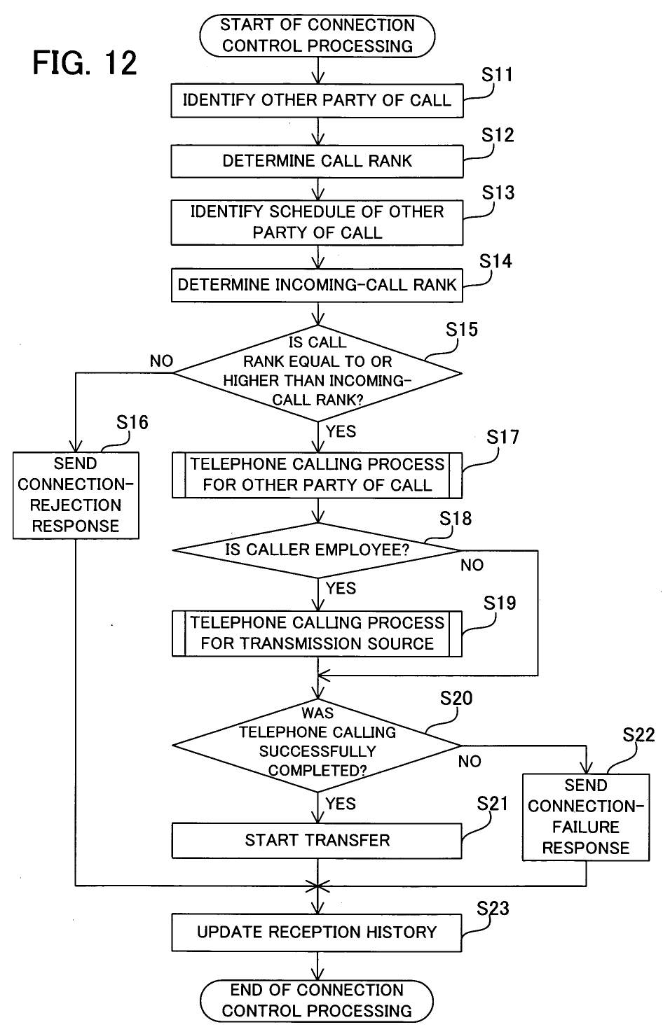

FIG. 12 is a flowchart of the procedure of connection control processing. The processing shown in FIG. 12 will be described below in the order of step numbers.

Step S11: When the connection-request receiving section 160 receives a telephone-call connection request, the connection-request receiving section 160 extracts the transmission-source telephone number and the transmission-destination telephone number from the received telephone-call connection request. Then, the connection-request receiving section 160 searches the employee information table 110a stored in the employee-information storage section 110 to identify the name of the employee having the extracted transmission-destination telephone number as a business telephone number. The connection-request receiving section 160 reports the extracted transmission-source telephone number and the identified employee name to the call-importance-level determination section 170. The connection-request receiving section 160 also reports the identified employee name to the schedule determination section 175.

Step 12: The call-importance-level determination section 170 searches the telephone directory table corresponding to the employee name received from the connection-request receiving section 160 among the telephone directory tables stored in the telephone-directory storage section 120 to obtain the telephone caller information corresponding to the transmission-source telephone number received from the connection-request receiving section 160. The call-importance-level determination section 170 reports the obtained telephone caller information to the connection determination section 180. When the telephone directory table does not include the telephone caller information corresponding to the transmission-source telephone number, the call-importance-level determination section 170 reports information that includes a name of “not registered” and a call rank of “6” to the connection determination section 180.

Step S13: The schedule determination section 175 searches the schedule information table corresponding to the employee name received from the connection-request receiving section 160 among the schedule information tables stored in the schedule-information storage section 130 to identify the working state corresponding to the current date and time.

Step S14: The schedule determination section 175 searches the call-device information table corresponding to the employee name received from the connection-request receiving section 160 among the call-device information tables stored in the call-device-information storage section 140 to obtain the call-device information corresponding to the working state identified in step S13. The schedule determination section 175 reports the obtained call-device information and the employee name to the connection determination section 180. When the working state identified in step S13 is “in a meeting”, the schedule determination section 175 also reports the meeting-room number to the connection determination section 180.

Step S15: When the connection determination section 180 receives the information from the call-importance-level determination section 170 and the schedule determination section 175, the connection determination section 180 compares the call rank in the received telephone caller information with the incoming-call rank in the received call-device information. When the call rank is lower than the incoming-call rank, the procedure proceeds to step S16. When the call rank is equal to or higher than the incoming-call rank, the procedure proceeds to step S17.

Step S16: The connection determination section 180 determines that telephone calling is not necessary, and reports that determination to the telephone calling section 185. The telephone calling section 185 sends a message indicating that the receiver cannot receive the call, to the transmission source of the telephone-call connection request when a telephone connection has been established with the transmission source.

Step S17: The connection determination section 180 determines that telephone calling is necessary, and reports the information received in step S15 to the telephone calling section 185. The telephone calling section 185 starts a telephone-calling process for the other party of the call according to the received information. The telephone calling section 185 does not wait for the telephone-calling process for the other party of the call to be completed, and the processing proceeds to step S18. The telephone-calling process will be described in detail later.

Step S18: The telephone calling section 185 refers to the employee information table 110a to determine whether the telephone caller is an employee. Specifically, the telephone calling section 185 determines whether the name of the caller included in the telephone caller information received from the connection determination section 180 is listed in the employee information table 110a. When the telephone caller is an employee, the procedure proceeds to step S19. When the telephone caller is not an employee, the procedure proceeds to step S20.

Step S19: The telephone calling section 185 starts a telephone calling process for the telephone caller. The procedure of the telephone calling process is the same as that performed in step S17.

Step S20: When the process of step S19 was executed, the telephone calling section 185 determines whether the telephone calling processes executed in steps S17 and S19 were both successfully completed. When the telephone calling processes executed in steps S17 and S19 were both successfully completed, the procedure proceeds to step S21. When either or both of the telephone calling processes failed, the procedure proceeds to step S22. When the process of step S19 was not executed, the telephone calling section 185 determines whether the telephone calling process executed in step S17 was successfully completed. When the telephone calling process executed in step S17 was successfully completed, the procedure proceeds to step S21. When the telephone calling process failed, the procedure proceeds to step S22.

Step S21: The telephone calling section 185 reports to the call transfer section 190 that telephone calling was successfully performed. The call transfer section 190 takes over the telephone connection established between the transmission source of the telephone-call connection request and the telephonic-communication control server 100 and the telephone connection established between the telephonic-communication control server 100 and the telephone-calling destination. Then, the call transfer section 190 starts relaying audio data between the two connections taken over.

Step S22: When the telephone connection with the transmission source of the telephone-call connection request is established, the telephone calling section 185 sends a message indicating that no response to telephone calling is received, to the transmission source.

Step S23: The telephone calling section 185 generates history information, and registers the generated history information in the reception history table 150a stored in the reception-history storage section 150. When the transfer of the telephone call was started in step S21, the telephone calling section 185 sets a success flag (indicated by a circle) in the incoming-call allowed field. When the process of step S16 was executed, the telephone calling section 185 sets a failure flag (indicated by x) in the incoming-call allowed field, and “connection rejected” in the reason field. When the process of step S22 was executed, the telephone calling section 185 sets a failure flag (indicated by x) in the incoming-call allowed field, and “no response” in the reason field.

The telephone calling processes executed in step S17 and step S19 will be described next.

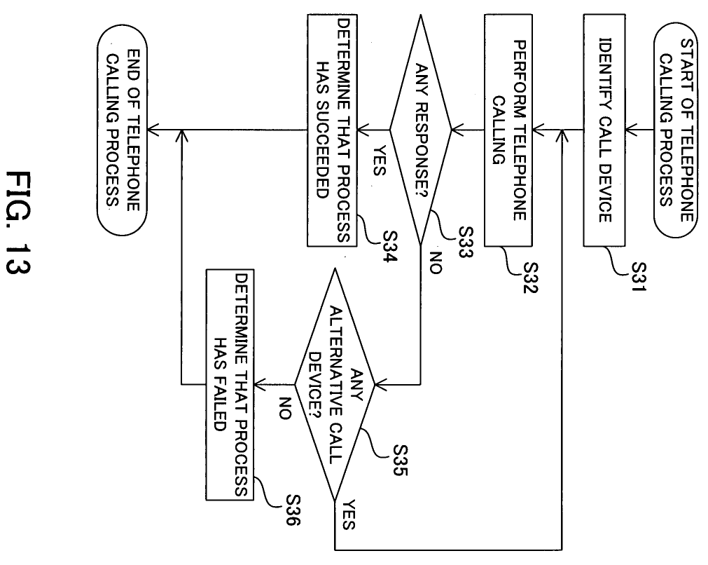

FIG. 13 is a flowchart of the procedure of the telephone calling process. The process shown in FIG. 13 will be described below in the order of step numbers.

Step S31: The telephone calling section 185 identifies one or more call devices and their priority levels. Specifically, when performing telephone calling directed to the other party of the call, the telephone calling section 185 identifies call devices and their priority levels according to the call device information received from the connection determination section 180. When performing telephone calling directed to the transmission source of the telephone-call connection request, the telephone calling section 185 calls the schedule determination section 175 with the name of the caller included in the telephone caller information received from the connection determination section 180 specified, and identifies call devices and their priority levels according to the call-device information received from the schedule determination section 175.

Step S32: The telephone calling section 185 selects a call device having the highest priority level in call devices to which telephone calling has not yet been performed among the call devices identified in step S31. The telephone calling section 185 searches the employee information table 110a corresponding to the name of the other party of the call received from the connection determination section 180 or the meeting-room information table 110b to identify the telephone number corresponding to the selected call device. Specifically, when the call device is an “extension telephone at the desk”, the telephone calling section 185 searches the employee information table 110a to extract the extension number corresponding to the name of the employee added in step S14. When the call device is a “portable telephone”, the telephone calling section 185 extracts the portable telephone number. When the call device is a “home telephone”, the telephone calling section 185 extracts the home telephone number. When the call device is an “extension telephone in a meeting room”, the telephone calling section 185 searches the meeting-room information table 10b to extract the extension number corresponding to the meeting-room number received from the connection determination section 180. Then, the telephone calling section 185 performs telephone calling directed to the telephone indicated by the identified telephone number.

Step S33: The telephone calling section 185 determines whether a response from the telephone of the calling destination is received within a predetermined period of time. When a response is received, the process proceeds to step S34. When no response is received, the process proceeds to step S35. The predetermined period to time for which a response is awaited is specified by the administrator in advance. For example, the period is set to 30 seconds.

Step S34: The telephone calling section 185 determines that the telephone calling process has been successfully performed.

Step S35: The telephone calling section 185 determines whether there is an alternative call device for which telephone calling has not yet been performed among the call devices identified in step S17. When there is an alternative call device, the process proceeds to step S32. When there is no alternative call device, the process proceeds to step S36.

Step S36: The telephone calling section 185 determines that the telephone calling process has failed.

As described above, when the connection-request receiving section 160 receives a telephone-call connection request, it identifies the employee serving as the other party of the call. The call-importance-level determination section 170 determines the call rank of the telephone caller for the other party of the call. The schedule determination section 175 identifies the current working state of the other party of the call and determines the incoming-call rank at the identified working state. The connection determination section 180 compares the call rank and the incoming-call rank and determines that telephone calling is necessary when the call rank is equal to or higher than the incoming-call rank. When it is determined that telephone calling is necessary, the telephone calling section 185 performs telephone calling according to the priority levels of call devices specified in advance by the other party of the call. When the telephone caller is an employee, the telephone calling section 185 performs telephone calling according to the priority levels of call devices specified in advance by the telephone caller. The call transfer section 190 starts call transfer when a response is received from the telephone calling destination.

It is assumed here that a telephone-call connection request is made with the employee A being specified as the other party of the call. It is also assumed that the schedule of the employee A is as shown in the schedule information table 130a of FIG. 9; the employee A has registered the telephone caller information described in the telephone-directory table 120a shown in FIG. 8; and the employee A has registered the call device information described in the call-device information table 140a shown in FIG. 10.

When an employee E makes a phone call to the employee A at 11:00 on December 1, although the employee A is out of office, the call rank (in this case, “4”) of the employee E is equal to the incoming-call rank (in this case, “4”) specified for “out of office”, the telephonic-communication control server 100 performs telephone calling directed to the portable telephone of the employee A. When a client “a” makes a phone call to the employee A at 11:15 on December 1, the employee A is out of office, and the call rank (in this case, “5”) of the client “a” is lower than the incoming-call rank specified for “out of office”, the telephonic-communication control server 100 does not perform telephone calling. When the client “a” makes a phone call to the employee A at 13:15 on December 1, the employee A is at the desk, and the call rank of the client “a” is higher than the incoming-call rank (in this case, “6”) specified for “at the desk”, the telephonic-communication control server 100 performs telephone calling directed to the telephone placed at the desk of the employee A.

With the use of the telephonic-communication control server 100, which executes the above-described telephone-call connection program, each employee of the company can specify the level of importance of a call made by each telephone caller registered in the telephone directory. In addition, each employee can specify the lowest level of importance at which telephone calling is allowed to be performed, for each working state. With these settings, control is easily implemented in which only telephone calls from an important client or the system administrator are allowed in a meeting and only telephone calls from the system administrator are allowed when at home.

Since each employee can specify the priority levels of call devices for each working state, a more stable call device can be selected with priority in audio communication. With this, control can be automatically performed in which a portable telephone is used when out of office, and a telephone placed in a meeting room is used in a meeting, which provides more stable audio communication than a portable telephone.

In the present embodiment, the telephonic-communication control server 100, installed in the company, is used for telephone-call connection control. A telephone-call connection service provided by a telecommunications carrier may be used. In that case, the functions of the telephonic-communication control server 100 are implemented on a computer owned by the telecommunications carrier and the functions are provided as a part of the telephone-call connection service.

In the present embodiment, when it is determined that telephone calling is not necessary, the telephonic-communication control server 100 sends a message to the transmission source of the telephone-call connection request. The telephonic-communication control server 100 may forward the telephone-call connection request to another device specified in advance. As the device to which the request is forwarded, a telephone used by a person in charge of receiving calls or an automatic answering device capable of recording a message can be used.

In the present embodiment, a call-device information table is prepared for each employee. A call-device information table prepared by the administrator in advance may be applied to all employees. In that case, incoming-call ranks for working states and selectable call devices conform to those determined by the company.

The above-described processing functions can be implemented by a computer. In that case, a program describing the contents of the processing of functions which the telephonic-communication control server 100 needs to have is provided. When the computer executes the program, the above-described processing functions are implemented on the computer. The program, which describes the processing contents, can be recorded in recording media which the computer can read. The recording media include, for example, magnetic recording devices, optical disks, magneto-optical recording media, and semiconductor memories. The magnetic recording devices include, for example, hard disk drives (HDDs), flexible disks (FDs), and magnetic tape. The optical disks include, for example, digital versatile discs (DVDs), DVD-RAMs, compact disc read only memories (CD-ROMs), compact disc recordables (CD-Rs), and compact disc rewritables (CD-RWs). The magneto-optical recording media include, for example, magneto-optical disks (MOs).

To distribute the program, portable recording media that have recorded the program, such as DVDs and CD-ROMs, are sold, for example. The program can be stored in a storage device in a server computer and transferred from the server computer to another computer through a network.

A computer which executes a telephone-call connection program stores, for example, the program recorded in a portable recording medium or the program transferred from a server computer, in its own storage device. Then, the computer reads the program from its own storage device and executes processing according to the program. The computer can directly read the program from the portable recording medium and execute the processing according to the program. Each time the program is transferred from the server computer, the computer can execute the processing according to the received program.

In the present invention, the level of importance of a call from each telephone caller is specified in advance for each telephone registered member, and a telephone call from a telephone caller who has a high level of importance is connected even in a time zone when a response is usually rejected. With this feature, each telephone registered member can receive only telephone calls which are considered to have a high level of importance to the registered member in a call-rejection time zone specified by the registered member.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A computer-readable recording medium having recorded therein a telephone-call connection program for controlling telephone calling according to a schedule of the other party of a call, the program making a computer serve as:
registered-member-information storage means for storing identification information for identifying telephone registered members individually and telephone numbers assigned to the telephone registered members, in association with each other;
transmission-source-information storage means for storing, for each telephone registered member, a telephone number assigned to a telephone caller and information indicating the call importance level of a call from the telephone caller for the telephone registered member, in association with each other;
schedule-information storage means for storing, for each telephone registered member, information on a response-rejection time zone that indicates a time zone when the telephone registered member does not want to receive telephone calling;
when receiving a telephone-call connection request that includes a transmission-source telephone number and a transmission-destination telephone number, connection-request receiving means for extracting the transmission-source telephone number and the transmission-destination telephone number from the received telephone-call connection request and also for referring to the registered-member-information storage means to identify a telephone registered member corresponding to the extracted transmission-destination telephone number;
call-importance-level determination means for referring to the transmission-source-information storage means to determine a call importance level corresponding to the transmission-source telephone number extracted by the connection-request receiving means, for the telephone registered member identified by the connection-request receiving means;
schedule determination means for referring to the schedule-information storage means to determine whether the current time falls in the response-rejection time zone of the telephone registered member identified by the connection-request receiving means;
connection determination means for determining that telephone calling is necessary when the schedule determination means determines that the current time does not fall in the response-rejection time zone; and for determining whether the call importance level determined by the call-importance-level determination means is equal to or higher than a reference importance level specified in advance, when the schedule determination means determines that the current time falls in the response-rejection time zone, and for determining that telephone calling is necessary when the call importance level determined by the call-importance-level determination means is equal to or higher than the reference importance level; and
telephone calling means for performing telephone calling directed to a terminal corresponding to the transmission-destination telephone number extracted by the connection-request receiving means when the connection determination means determines that telephone calling is necessary.

2. The computer-readable recording medium having recorded therein the telephone-call connection program according to claim 1, wherein, when the connection determination means does not determine that telephone calling is necessary, the telephone calling means sends a message indicating that the call cannot be responded, to the transmission source of the telephone-call connection request.

3. The computer-readable recording medium having recorded therein the telephone-call connection program according to claim 1, wherein the registered-member-information storage means stores a first telephone number and a second telephone number different from the first telephone number, in association with the identification information of each telephone registered member; and
the telephone calling means performs telephone calling directed to a terminal identified by the first telephone number of the telephone registered member identified by the connection-request receiving means when the current time does not fall in the response-rejection time zone; and performs telephone calling directed to a terminal identified by the second telephone number of the telephone registered member identified by the connection-request receiving means when the current time falls in the response-rejection time zone.

4. The computer-readable recording medium having recorded therein the telephone-call connection program according to claim 1, wherein the registered-member-information storage means stores a first telephone number and a second telephone number different from the first telephone number, in association with the identification information of each telephone registered member; and
the telephone calling means performs telephone calling directed to a terminal identified by the first telephone number of the telephone registered member identified by the connection-request receiving means, and, when no response is received from the terminal identified by the first telephone number within a predetermined period of time, the telephone calling means further performs telephone calling directed to a terminal identified by the second telephone number of the telephone registered member identified by the connection-request receiving means.

5. The computer-readable recording medium having recorded therein the telephone-call connection program according to claim 1, wherein the schedule-information storage means stores information on a response-rejection reason in association with the information on each response-rejection time zone;
when the schedule determination means determines that the current time falls in the response-rejection time zone, the schedule determination means further identifies, among reason-basis reference importance levels specified in advance for the response-rejection reasons, the reason-basis reference importance level of a response-rejection reason corresponding to the current time; and
when the schedule determination means determines that the current time falls in the response-rejection time zone, the connection determination means determines whether telephone calling is necessary, using the reason-basis reference importance level identified by the schedule determination means as the reference importance level.

6. The computer-readable recording medium having recorded therein the telephone-call connection program according to claim 1, wherein the schedule-information storage means stores information on a response-rejection reason in association with the information on each response-rejection time zone, and also stores, for each telephone registered member, the information on the response-rejection reasons and information on reason-basis reference importance levels in association with each other;
when the schedule determination means determines that the current time falls in the response-rejection time zone, the schedule determination means further identifies the reason-basis reference importance level of a response-rejection reason corresponding to the current time; and
when the schedule determination means determines that the current time falls in the response-rejection time zone, the connection determination means determines whether telephone calling is necessary, using the reason-basis reference importance level identified by the schedule determination means as the reference importance level.

7. The computer-readable recording medium having recorded therein the telephone-call connection program according to claim 1, wherein, when the transmission-source telephone number extracted by the connection-request receiving means is not stored in the transmission-source-information storage means, the call-importance-level determination means determines a lowest importance level specified in advance as the call importance level corresponding to the transmission-source telephone number.

8. A telephone-call connection method for controlling telephone calling according to a schedule of the other party of a call, comprising the steps of:
when receiving a telephone-call connection request that includes a transmission-source telephone number and a transmission-destination telephone number, connection-request receiving means extracting the transmission-source telephone number and the transmission-destination telephone number from the received telephone-call connection request and also referring to registered-member-information storage means that stores identification information for identifying telephone registered members individually and telephone numbers assigned to the telephone registered members, in association with each other, to identify a telephone registered member corresponding to the extracted transmission-destination telephone number;
call-importance-level determination means referring to transmission-source-information storage means that stores, for each telephone registered member, a telephone number assigned to a telephone caller and information indicating the level of importance of a call from the telephone caller for the telephone registered member, in association with each other, to determine a call importance level corresponding to the transmission-source telephone number extracted by the connection-request receiving means, for the telephone registered member identified by the connection-request receiving means;
schedule determination means referring to schedule-information storage means that stores, for each telephone registered member, information on a response-rejection time zone that indicates a time zone when the telephone registered member does not want to receive telephone calling, to determine whether the current time falls in the response-rejection time zone of the telephone registered member identified by the connection-request receiving means;
connection determination means determining that telephone calling is necessary when the schedule determination means determines that the current time does not fall in the response-rejection time zone; and determining whether the call importance level determined by the call-importance-level determination means is equal to or higher than a reference importance level specified in advance, when the schedule determination means determines that the current time falls in the response-rejection time zone, and determining that telephone calling is necessary when the call importance level determined by the call-importance-level determination means is equal to or higher than the reference importance level; and
telephone calling means performing telephone calling directed to a terminal corresponding to the transmission-destination telephone number extracted by the connection-request receiving means when the connection determination means determines that telephone calling is necessary.

9. A telephone-call connection apparatus for controlling telephone calling according to a schedule of the other party of a call, comprising:
registered-member-information storage means for storing identification information for identifying telephone registered members individually and telephone numbers assigned to the telephone registered members, in association with each other;
transmission-source-information storage means for storing, for each telephone registered member, a telephone number assigned to a telephone caller and information indicating the call importance level of a call from the telephone caller for the telephone registered member, in association with each other;
schedule-information storage means for storing, for each telephone registered member, information on a response-rejection time zone that indicates a time zone when the telephone registered member does not want to receive telephone calling;
when receiving a telephone-call connection request that includes a transmission-source telephone number and a transmission-destination telephone number, connection-request receiving means for extracting the transmission-source telephone number and the transmission-destination telephone number from the received telephone-call connection request and also for referring to the registered-member-information storage means to identify a telephone registered member corresponding to the extracted transmission-destination telephone number;
call-importance-level determination means for referring to the transmission-source-information storage means to determine a call importance level corresponding to the transmission-source telephone number extracted by the connection-request receiving means, for the telephone registered member identified by the connection-request receiving means;
schedule determination means for referring to the schedule-information storage means to determine whether the current time falls in the response-rejection time zone of the telephone registered member identified by the connection-request receiving means;
connection determination means for determining that telephone calling is necessary when the schedule determination means determines that the current time does not fall in the response-rejection time zone; and for determining whether the call importance level determined by the call-importance-level determination means is equal to or higher than a reference importance level specified in advance, when the schedule determination means determines that the current time falls in the response-rejection time zone, and for determining that telephone calling is necessary when the call importance level determined by the call-importance-level determination means is equal to or higher than the reference importance level; and
telephone calling means for performing telephone calling directed to a terminal corresponding to the transmission-destination telephone number extracted by the connection-request receiving means when the connection determination means determines that telephone calling is necessary.
